(19) United States
(12) Patent Application Publication
(10) Pub. No.: US 2022/0332645 A1
(43) Pub. Date: Oct. 20, 2022

(54) PHOTOCATALYTICALLY ACTIVE AEROGEL CONCRETE

(71) Applicants: Universität Duisburg-Essen, Essen (DE); Deutsches Zentrum Für Luft- Und Raumfahrt E.V., Köln (DE)

(72) Inventors: Martina SCHNELLENBACH-HELD, Essen (DE); Torsten WELSCH, Hennef (DE); Barbara MILOW, Hurth (DE)

(21) Appl. No.: 17/635,543

(22) PCT Filed: Aug. 18, 2020
(86) PCT No.: PCT/EP2020/073065

§ 371 Date: Feb. 15, 2022

(30) Foreign Application Priority Data
Aug. 22, 2019 (DE) 10 2019 122 616.3

(51) Int. Cl. C04B 28/04; C04B 40/00; C04B 18/02; C04B 18/14; C04B 22/06; C04B 18/08; B01J 21/06; B01J 23/745; B01J 35/00; B01D 53/86

(52) U.S. Cl. CPC C04B 28/04; C04B 40/0039; C04B 18/027; C04B 18/146; C04B 22/06; C04B 18/08; B01J 21/063; B01J 23/745; B01J 35/004; B01D 53/8628; C04B 2103/32

(57) ABSTRACT

The invention relates to an aerogel concrete mixture containing a photocatalyst, a photocatalytically active high-performance aerogel concrete obtainable therefrom and a method for producing same.

### CROSS-REFERENCED TO RELATED APPLICATION(S)

This application is a U.S. National Stage Entry Under 35 U.S.C. 371 of International Application No. PCT/EP2020/073065 filed on Aug. 18, 2020, which claims priority to German Patent Application 10 2019 122 616.3 filed on Aug. 22, 2019, the contents of which are incorporated herein by reference in their entirety.

### FIELD OF THE INVENTION

The present invention relates to an aerogel concrete mix containing a photocatalyst, a photocatalytically active high-performance aerogel concrete obtainable therefrom, and to a process for the preparation thereof.

### BACKGROUND OF THE INVENTION

Air pollution from noxious substances, such as nitric oxides or volatile hydrocarbons (VOC), is an acute issue currently and in the long run, especially in inner city areas. In order to comply with the corresponding limits set by the European Union and thus to protect the public from harmful concentrations of noxious substances, the NOₓ pollution in the air has to be reduced urgently. For this, two different approaches are possible: On the one hand, it is possible to reduce the pollutant emissions, which are predominantly produced by traffic. Thus, reference is made to the currently discussed driving ban on older diesel passenger cars, and to the efforts of politicians and the automobile industry to lower the emissions by promoting electric vehicles or less pollutant internal combustion engines. Another possibility is to remove the pollutants contained in the air by suitable methods as much as possible. In this context, photocatalytically active surfaces are to be mentioned, among other things. They cause oxidation and thus degradation of the pollutants by using illuminated catalysts. From the nitric oxides, nitrates are formed, which are washed off and drained into the ground water when rain falls onto the surface. This regenerates the surface, so that the same process can proceed again.

The basis of the photocatalytic decomposition of air pollutants is the interaction of a photosemiconductor with light of specific wavelengths. Complex redox reactions are triggered that may lead to the degradation of different organic and inorganic compounds, such as soilings or air pollutants. Titanium dioxide (TiO₂), for example, in the form of anatase, is usually employed as the photosemiconductor; it can be excited with UV light and converts nitric oxides to harmless nitrate, inter alia, in the presence of atmospheric humidity and oxygen through several intermediates. Thus, titanium dioxide enables the degradation of both air pollutants and noxious substances and soilings on surfaces. In addition, a superhydrophilic surface is formed, which may cause an additional cleaning effect.

The critical quantities for this reaction are the light intensity, the concentration of noxious substances, and the atmospheric humidity. An increase of the total surfaces of a photocatalytic material is necessary to increase the total degradation of noxious substances. As fine as possible titanium dioxide having a high specific surface is usually used for the reaction to enhance efficiency. However, fine materials have a strong tendency to agglomerate. Such agglomerates are hardly disrupted in usual mixing processes, and therefore, it is by far not possible to utilize the full potential of the large TiO₂ surface to improve the photocatalytic activity.

The effectiveness of photocatalytically active surfaces of components depends on numerous parameters. In addition to the climatic boundary conditions (UV-A radiation intensity, wind velocity), the geometric boundary conditions (photocatalytically active area, height of building, width of urban canyons) and the deposition rate of the photocatalyst employed are essential. For the currently available TiO₂-based photocatalysts, the deposition rates are about 0.2 to 0.4 cm/s. To date, reduction rates for the degradation of NO₂ or NOₓ have been determined by measurements only for photocatalytically active concrete paving areas. The information relating to photocatalytically active facade surfaces is essentially based on model calculations. When existing in situ measurements are evaluated, different measuring heights are to be taken into account, and model calculations should make realistic assumptions for the above mentioned parameters. Therefore, the reduction rates stated in the literature show very large variations of from 2 to 80%. For concrete paving areas that have been equipped with photocatalysts on squares in Germany, NOₓ reduction rates of 20 to 35% are stated for a measuring level of 3.00 m above ground. Model calculations for city canyons with photocatalytically active facades and traffic lanes yield possible reduction rates of about 10 to 25%. Because of the large influence of the above mentioned parameters, which are in part subject to significant variations, these values are to be understood as trends. However, it becomes clear that even in a country like Germany that gets comparatively little solar radiation, photocatalytically active surfaces of components have a great potential to make a contribution to air purification.

Such catalysts, namely titanium dioxide (TiO₂), have already been embedded in concretes, to thus enable a photocatalytic air purification to be performed on large inner city areas. Until now, the focus has been on horizontal surfaces of concrete, for example, concrete lanes or concrete pavings. The use thereof on vertical surfaces, for example, facades, is hardly possible currently, because exposed concrete facades can be realized only in a very limited way, namely in the form of mounted facade elements in double-skin construction, because of thermal insulation requirements.

This is due to the high thermal conductivity of normal concrete of λ≈2.5 W/(mK). For this reason, additional measures, such as the application of an external heat insulation, are taken to reduce the heat transition coefficient of components in contact with the outside air. These involve disadvantages in terms of building physics, ecology and design, and in view of fire protection. In order to avoid the use of an additional insulation level, high strength lightweight construction concretes were employed already in the 1990's, in which the conventional grains of rock were exchanged against mineral aggregates with porous grains, such as expanded clay, expanded shale, or foam glass. In this way, the thermal conductivities can be reduced to a range of from 0.40 to 1.35 W/(mK) while the compressive strength is comparable to that of normal concrete, which still requires a relatively large wall thickness, however.

### BRIEF SUMMARY OF THE INVENTION

Thus, the photocatalytic concretes described in the prior art are not suitable for large-area use on vertical surfaces because of their disadvantageous ratio of compressive strength to thermal conductivity.

A promising approach for the production of lightweight construction concretes with a low thermal conductivity includes so-called aerogel concretes, in which fused silica aerogel granules (SiO₂), in particular, are embedded in cement matrices.

An aerogel is an ultralightweight matrix material that mainly consists of air, the production thereof being performed through a chemical process (sol-gel process). It has an open spongy nanostructure, and is one of the lightest existing materials, with a typical density within a range of from 2 to 250 kg/m³. The pores of the gel are so small that the air contained therein cannot contribute to heat transport, because the pore sizes are below the mean free path of air. Accordingly, the thermal conductivity of the aerogels is a very low value of from 0.017 to 0.021 W/(mK) (conventional heat insulation: 0.04 W/(mK)).

An aerogel-based mineral building material has been known, for example, from DE 10 2004 046 495 B4. It discloses aerogel concretes having an aerogel content of 50 to 75% by volume, and resulting therefrom, hardened concrete bulk densities of from 580 to 1050 kg/m³. The compressive strengths determined on prisms having edge lengths of 40 mm were from 0.6 to 1.5 MPa, and the determined thermal conductivity was only λ=0.10 W/(mK).

Moreover, excellent properties could be found in view of fire protection and sound insulation. In studies on aerogel-containing lightweight concretes performed by Hub et al. (Hub et al., Leichtbeton mit Aerogelen als Konstruktionswerkstoff, Beton- and Stahlbau 2013, vol. 9, pp. 654-661), it was found that aerogel concrete can be reutilized by conventional demolition, followed by crushing and separation into different grain size fractions. The compressive strength studies yielded compressive strengths of from 1.4 to 2.5 MPa at dry bulk densities of from 500 to 620 kg/m³. The thermal conductivities varied between λ=0.06 W/(mK) (phd=400 kg/m³) and λ=0.1 W/(mK) (phd=570 kg/m³), wherein, as the bulk density decreased, there was also a reduction in thermal conductivity and compressive strength. The aerogel concrete showed a high tendency to shrinking (2.2 mm/m) and a coefficient of thermal expansion of α=5.3·10⁻⁶ 1/K. In the tests for the frost resistance of aerogel concrete, a hardly measurable weathering loss was determined.

Gao et al. (Gao et al., Aerogel-incorporated concrete: An experimental study, Construction and Building Materials 2014, pp. 130-136) examined aerogel-modified concretes with aerogel contents of from 0 to 60% by vol. (phd=1000 to 2300 kg/m³). At an aerogel content of 60% by volume, a thermal conductivity of 0.26 W/(mK), a compressive strength of 8.3 MPa and a flexural strength of 1.2 MPa were determined.

Ng et al. (Ng et al., Experimental investigations of aerogel-incorporated ultra-high performance concrete, Construction and Building Materials 2015, pp. 307-316) examined the dependency between the aerogel content and fresh concrete bulk density, hardened concrete bulk density, flexural and compressive strengths and thermal conductivity for an UHPC aerogel mortar. The determined thermal conductivities were from 2.3 W/(mK) for a pure UHPC mortar, and 0.31 W/(mK) for an aerogel mortar with 80% by volume of aerogel. At an aerogel content of 80% by volume, the compressive strength was not measurable, and the flexural strength was 0.2 MPa. At 50% by volume of aerogel, a compressive strength of 20 MPa and a thermal conductivity of 0.55 W/(mK) were measured.

To conclude, the aerogel concretes developed to date have excellent construction-physical properties in view of thermal and sound insulation, and fire protection, but have compressive strengths that are insufficient for applications in constructional practice.

WO 2016/202718 discloses a high-performance aerogel concrete, which contains from 10 to 85% by vol./m³ of aerogel granules with a grain size within a range of from 0.01 to 4 mm. This material is characterized by an extremely favorable ratio of bulk density to compressive strength, compressive strength to thermal conductivity, and excellent sound insulation properties. The material has no photocatalytic properties.

It has been the object of the present invention to provide a photocatalytically active high-performance aerogel concrete characterized by an improved ratio of bulk density to compressive strength, compressive strength to thermal conductivity, and excellent sound insulation properties as compared to the prior art. In particular, a photocatalytically active concrete is to be provided that can be employed in vertical surfaces, such as facades, especially exposed concrete facades.

According to an embodiment, disclosed is an aerogel concrete mix containing from 10 to 85 kg/m³ of aerogel granules with a grain size within a range of from 0.01 to 4 mm, 100 to 900 kg/m³ of an inorganic binder, 10 to 36 kg/m³ of at least one silica fume suspension, based on the binder content, 1 to 45 kg/m³ of at least one superplasticizer, based on the binder content, 0.2 to 9 kg/m³ of at least one superplasticizer, based on the binder content, 0 to 1200 kg/m³ of at least one lightweight aggregate, wherein the aerogel concrete mix further contains a photocatalyst.

### BRIEF DESCRIPTION OF THE DRAWING

The present invention is illustrated and described herein with reference to the drawing in which:

FIG. 1 illustrates a diagram showing the results of the compressive strength (DF) and flexural strength (BF) tests performed on mortar prisms, according to embodiments.

### DETAILED DESCRIPTION OF THE INVENTION

In a first embodiment, the object of the invention is achieved by an aerogel concrete mix containing

from 10 to 85 kg/m³ of aerogel granules with a grain size within a range of from 0.01 to 4 mm,

100 to 900 kg/m³ of an inorganic, especially hydraulic, binder,

10 to 360 kg/m³ of at least one silica fume suspension,

1 to 45 kg/m³ of at least one superplasticizer,

0.2 to 9 kg/m³ of at least one stabilizer,

0 to 1200 kg/m³ of at least one lightweight aggregate,

characterized in that said aerogel concrete mix contains a photocatalyst.

A high-performance aerogel concrete mix without a photocatalyst is known from WO 2016/202718, the entire content of which is incorporated herein by reference. In particular, the aerogel concrete mix according to the invention may contain the further ingredients described in WO 2016/202718 in the amounts as mentioned therein,

From DE 199 24 453 A1, a molded part obtainable from a mixture can be seen, wherein said mixture contains

silica gel,

a binder in the form of porous silica, for example, ultrafinely divided porous silica,

a superplasticizer,

cellulose ether, starch (both stabilizers),

a solvent (water), and

mixed oxides SiO₂/TiO₂.

There is no information relating to the photoactivity. It is known that not all modifications of titanium dioxide are photocatalytically active.

Recent developments in binder technology show that non-hydraulic binders could also play a role in the future. Examples include alkali-activated binders, geopolymers, carbonated calcium silicates, or magnesia or phosphate binders. The binding may then be effected by hydration, polymerization, carbonating, or an acid-base reaction.

According to the invention, “silica fume” is interchangeable with the terms “silica gel” and “silica”, because this term is more familiar than “silica gel” in “concrete circles”.

Mixtures optimized according to the invention also contain fibers. For example, carbon, glass, ceramic and steel fibers have been employed. However, plastic fibers and natural fibers can also be employed without a problem.

Surprisingly, it has been found that the particular properties of the high-performance aerogel concrete with respect to the ratio of bulk density to compressive strength, and compressive strength to thermal conductivity, and the excellent sound insulation properties are maintained even after the addition of a photocatalyst to the aerogel concrete mix. The high-performance aerogel concrete according to the invention is moreover completely inorganic and thus incombustible, non-toxic, and non-cancerogenic. The material is open to diffusion and water-retarding, and is excellently suitable, for these reasons too, for the preparation of exterior components and facades with photocatalytic properties.

According to embodiments of the invention, said aerogel concrete mix is provided with the further property of photocatalysis by adding a photocatalyst, and thus developed further into a multifunctional building material. Thus, the use of photocatalytically active materials surprisingly becomes possible even at vertical surfaces. By means of the aerogel concrete mix according to the invention, facade elements, ready-made parts or bricks can be produced, in which supporting, heat-insulating, sound-insulating, fire-protecting and air-purifying properties can be combined without further process operations or further use of materials.

Surprisingly, it has been found that multilayered components of aerogel concrete can be manufactured using the aerogel concrete mix according to the invention in a “fresh-on-hardened” method. The shear and adhesive pull strengths that can be achieved are clearly above the requirements relevant to constructional practice. This property can be utilized in the preparation of photocatalytically effective graded components by adding said photocatalyst only to the layer of the components close to the surface. In such a grading, the actual construction body is prepared at first in the thickness required for mechanical or construction-physical reasons, and then a photocatalytically active high-performance aerogel concrete layer having a thickness of only a few millimeters is applied. This process allows the photocatalytically active layer to be applied also afterwards, so that graded components can be prepared in both new construction and construction in existing buildings (for example, in the form of shotcrete). Further, it is conceivable that the aerogel concrete according to the invention is employed as curtain-type facades for thin-walled facade elements. This saves resources, and the use of expensive photocatalysts, especially TiO₂, is reduced to a minimum.

Based on the mixing compositions for high-performance concrete (HPC), ultrahigh-performance concrete (UHPC) and lightweight concrete (LC), mixtures for photocatalytically active aerogel concrete are provided by the present invention. The photocatalytically active aerogel concrete according to the invention has extraordinary heat-insulating properties, and a compressive strength comparable to that of normal concrete, and combines them with the ability of photocatalytic air cleaning. The excellent heat insulation properties are achieved by using aerogel granules in an amount of 10 to 85 kg/m³, preferably 70 kg/m³, especially 60 to 65, preferably 50 to 70 kg/m³. The grain size of the aerogel is from 0.01 to 4 mm, especially from 1 to 4 mm. This grain size can be obtained by simple screening. It removes fine components, especially dust. The presence of such fine components leads to a deterioration of the compressive strength values.

Each suitable material may be employed as the starting material for said aerogel granules. In particular, fused silica aerogel granules (SiO₂), granules based on metallic oxides, or mixtures thereof may be employed.

When concretes and mortar are mixed, sand is usually added to the mix. According to embodiments of the invention, however, sand and coarse aggregates are preferably dispensed with completely (except mixes with additional lightweight aggregates).

Any binder known from the prior art of concrete mixes may be employed as an inorganic binder. Preferably, said inorganic binder includes hydraulic binders, such as cement, especially Portland cement. In a preferred embodiment, the aerosol concrete mix according to the invention contains from 500 to 550 kg/m³ of an inorganic, especially hydraulic, binder.

Silica fume suspensions within the meaning of the present invention are commercially available and include, in particular, a very reactive amorphous microsilica-water mixture with a high specific surface area, for example, MC Centrilit Fume SX: a Blaine value of 20000, i.e., 4 to 5 times as much as cement/binder.

The silica fume may be added in powder form or as a suspension, wherein the solids content of the suspension is usually 50% by volume. That is, the silica fume suspension has a content of active ingredient of 50% by volume, and 50% by volume usually consists of water.

In a preferred embodiment, the silica fume suspension contains from 1 to 60% by volume, especially 50% by volume, of active substance (solids content).

Superplasticizers within the meaning of the present invention are commercially available and include, in particular, commercially available polycarboxylates, for example, Powerflow 3100: polycarboxylate ethers with a solids content of 30% by weight, a high charge density, and short side chains.

Stabilizers within the meaning of the present invention are commercially available and include, in particular, commercially available organic polymers, for example, MC Stabi 520, water-absorbent and water-retaining cellulose.

In addition to the components of the aerogel concrete mix as mentioned above, the mixtures according to the invention may also contain further usual concrete additives and concrete admixtures.

Concrete admixtures are defined in the European standards EN 934 “Admixtures for concrete, mortar and grout”, which are binding in all CEN member states. Part 2 of EN 934 contains the definitions and requirements for concrete admixtures:

“A material added during the mixing process of concrete in a quantity not more than 5% by mass of the cement content of the concrete, to modify the properties of the mix in the fresh and/or hardened state.”

EN 934-2 contains definitions and requirements for the following individual groups of active ingredients:

Concrete plasticizers,

Superplasticizers,

Stabilizers,

Air-entraining agents,

Accelerators: Hardening accelerators and setting accelerators:

Retarders, and

Sealants.

Sand (grain bulk density ρ>2000 kg/m³) is generally not required, because it is replaced by aerogel granules or/and lightweight aggregates. “Lightweight aggregates” means lightweight aggregates of rock or lightweight sands with a grain bulk density of ρ≤2000 kg/m³.

According to embodiments of the invention, the aerogel concrete mixture contains a photocatalyst. Preferably, the aerogel concrete mixture contains 0.01 to 66% by mass of the cement content of a photocatalyst. More preferably, the content of photocatalyst is from 1 to 10% by mass of the cement content, even more preferably from 3 to 5% by mass of the cement content. A lower content of photocatalyst has the disadvantage that the photocatalytic activity is insufficient for applications in construction practice. A higher content of photocatalyst has the disadvantage that the compressive strength and durability of the hardened reaction product may be reduced. The limits correspond to the values from the literature and the maximum content of additives admissible according to the standard (in this case for fly ash, the limit is between 25 and 33% for other additives, and no limit is stated for pigments). Deviating from the remaining procedure, the values are stated here in percent by mass of the cement content, because this is the usual form of rendering in the literature.

As the photocatalyst, any material known in the prior art may be employed that is suitable for catalyzing the conversion of air pollutants, such as nitric oxides or volatile hydrocarbons, in particular, to harmless, preferably water-soluble, materials. Preferably, an inorganic photocatalyst is employed.

In a preferred embodiment, the photocatalyst is selected from oxides of titanium, iron, zinc, tin, tungsten, niobium, tantalum, and mixtures thereof. More preferably, the photocatalyst comprises or consists of titanium dioxide (TiO₂). The photocatalyst may also comprise titanium dioxide in admixture with other photoactive materials. If titanium dioxide is employed as the photocatalyst, it is preferably in the form of anatase.

The photocatalyst is preferably incorporated into the aerogel concrete mix in the form of a powder, or in the form of a suspension. The photocatalyst preferably has a crystallite size within a range of from 0.1 nm to 10000 nm, more preferably from 2 to 100 nm, especially 15 nm. A higher crystallite size has the disadvantage that the photocatalytic activity is insufficient.

Preferably, the photocatalyst has a high specific surface area. The specific surface area (BET) of the photocatalyst is preferably within a range of from 10 to 1200, more preferably 150 to 300, especially 225 m²/g. A lower specific surface area has the disadvantage that the active sites are not available.

In order to increase the photocatalytic effectiveness of the aerogel concrete mix according to embodiments of the invention or of aerogel concretes obtained therefrom, the photocatalyst is preferably uniformly distributed in said aerogel concrete mix. In a preferred embodiment, the aerogel concrete mix according to embodiments of the invention therefore includes a material that inhibits the agglomeration of the photocatalyst, in order to promote as uniform as possible a distribution, and increase the processability of the material. Preferably, the photocatalyst is incorporated into the aerogel concrete mix in admixture with the material that inhibits agglomeration.

Aa the material that inhibits the agglomeration of the photocatalyst, pozzolans, especially fly ash, trass, lava, silica fume, metakaolin, rice husk ash, calcined clay, or mixtures thereof may be employed. Fly ash, especially coal fly ash, has proven particularly effective. “Fly ash” within the meaning of the present invention means the solid, finely divided (particulate, particle-shaped, dust-like) residue of combustions that is discharged together with the flue gases because of its high dispersity (being finely divided).

The composition of fly ash strongly depends on the fuel (for example, lignite or coal), and ranges from residual carbon and minerals (quartz, aluminum silicate) to toxic materials, such as heavy metals (arsenic to zinc) and dioxins. Coal fly ash mainly consists of the amorphous phases of silicon, aluminum and iron oxides formed from the natural coal-accompanying materials.

The addition of fly ash effectively prevents the agglomeration of the photocatalyst, which results in a better distribution and processability of the photocatalyst, and in a lower consumption of material. In addition, fly ash has a positive effect in fresh concrete and hardened concrete because of its grain structure and pozzolanic property. In fresh concrete, the processing of the concrete is easier; in hardened concrete, the compressive strength of the concrete is increased, and the durability of the concrete structure is also improved because of the more compact concrete structure.

In a preferred embodiment, the photocatalyst comprises a material inhibiting agglomeration, especially fly ash, in an amount of from 50 to 95% by weight, more preferably 65 to 85% by weight, especially 75% by weight, based on the total amount of photocatalyst and agglomeration inhibitor.

In an alternative embodiment, the object of the invention is achieved by a process for preparing an aerogel concrete with the aerogel concrete mix according to the invention, wherein at first the binder, photocatalyst, aerogel and optionally lightweight aggregates are mixed, then a water-superplasticizer mixture and the stabilizer are added, in a mixing break a water-silica fume mixture is added, and after renewed mixing, the remaining water is added, mixing further. The order of mixing is of particular importance.

Of course, for the preparation of facade elements, ready-made components or bricks, further process steps are required, and altogether familiar to the skilled person.

Mixtures for high strength (HPC) and ultra high strength concretes (UHPC) are usually prepared as described in Bundesverband der deutschen Zementindustrie, Zement-Merkblatt Betontechnik B 16.10.2002, Hochfester Beton/Hochleistungs-beton. Leipzig 2002: “In order to achieve an optimum homogenization, especially of the ultrafine materials, the dosing order of grains of rock, cement, water and subsequently fly ash and silica fume suspension has proven favorable. For an optimum effect of the additives, they should be dosed after the addition of water and silica fume.” Aerogel concrete mixes prepared in this way have low compressive strengths and performances, as demonstrated by the state of research and our own studies.

As compared to this mixing order familiar to those skilled in the art, the mixing protocol in the process according to embodiments of the invention has preferably been changed as follows: Premixes of the liquid components are prepared in advance. Thus, ⅓ of the water to be added is mixed with the superplasticizer, and ¼ of the water to be added is mixed with the silica fume suspension. Thereafter, the binder, the photocatalyst, the aerogel granules, and the lightweight aggregates, if any, are mixed together. After a mixing time of 30 to 60 seconds, the water-superplasticizer mixture and the stabilizer are added to the mixture. After a mixing time of about 30 to 60 seconds, the mixture of water and silica fume is added. After mixing again for 30 seconds to 2 minutes, the dosing containers for the silica fume suspension and the superplasticizer are filled with 50% by volume each of the remaining water to be added, rinsed with it, and discharged into the mixer. The total mixture is mixed for another 1 to 10 minutes, before it can be processed. The mixtures prepared in this way surprisingly showed a considerably higher compressive strength and performance as compared to those prepared using conventional mixing protocols.

The water to be added is dosed in such a way that water/binder (w/b) values of from 0.15 to 1.00, especially from 0.20 to 0.60, preferably from 0.28 to 0.35, result. For calculating the w/b value, only the proportion of the binder without further solid components, such as the silica fume, is to be employed.

Particularly low w/b values and thus high compressive strengths are obtained if the added water is cooled before being mixed with the solid components, especially to a temperature of less than 10° C., more preferably to less than 5° C.

In another alternative embodiment, the object of the invention is achieved by photocatalytically active high-performance aerogel concretes, in-situ concretes, precast concrete parts, facade elements, sprayed concrete linings, or outer layers of graded wall elements, obtainable by the method according to the invention as described above.

“Graded aerogel concrete” within the meaning of the invention means that construction elements are prepared from at least two layers of different aerogel concrete mixes. Such components can be manufactured “fresh in fresh” or “fresh onto hard”. In the first case, the first layer of aerogel concrete is first put into place, and the second layer is produced immediately thereafter, even before the first layer has hardened. In the “fresh onto hard” method, the second layer is prepared only after the first layer has hardened. Independently of the selected method, a final product having a multilayer structure is obtained, wherein the layers are bonded together in a pressure-resistant, tension-resistant and shear-resistant way.

Construction elements with photocatalytically active aerogel concrete prepared from the stated mixing compositions and according to the described mixing protocol are surprisingly characterized, as compared to the previously known photocatalytically active concretes, by a very short hardening time and a very fast development of strength. After only 15 to 30 minutes, setting of the fresh concrete can be observed, and after about 26 hours, the hydration process is almost complete, so that the compressive strength at that time is already about 80% of the compressive strength after 28 days.

In another embodiment, the object of the invention is achieved by the use of an aerogel concrete mix according to the invention for photocatalytic surfaces, especially for degrading nitric oxides.

In another embodiment, the object of the invention is achieved by the use of a photocatalytic high-performance aerogel concrete, in-situ concrete, precast concrete part, facade element, sprayed concrete lining, or outer layer of graded wall elements according to the invention for photocatalytic surfaces, especially for degrading nitric oxides.

### Embodiments/Examples

Mortar prisms with dimensions of 160 mm×40 mm×40 mm according to DIN EN 196 with the mixing compositions V1, V2, 1, 2 and 3 according to Table 1 were prepared. The mixtures V1 and V2 are comparative experiments, the mixtures 1, 2 and 3 are aerogel concrete mixes according to the invention.

TABLE 1
Mixing compositions (in kg/m³)

| | V1 | V2 | 1 | 2 | 3 |
|---|---|---|---|---|---|
| Cement | 798.3 | 718.5 | 718.5 | 771.7 | 771.7 |
| TiO₂ | — | — | 26.6 | 26.6 | |
| Fe₂O₃ | — | — | — | — | 26.6 |
| Fly ash | — | 79.8 | 53.2 | — | — |
| Silica fume | 207.6 | 207.6 | 207.6 | 207.6 | 207.6 |
| suspension | | | | | |
| Aerogel granules | 46.4 | 46.4 | 46.4 | 46.4 | 46.4 |
| Superplasticizer | 28.3 | 28.3 | 28.3 | 28.3 | 28.3 |
| Stabilizer | 4.0 | 4.0 | 4.0 | 4.0 | 4.0 |
| Water | 90.2 | 90.2 | 90.2 | 90.2 | 90.2 |

The following products were employed:

Cement: Portland cement CEM I 52, 5R (Milke Premium® of the company HeidelbergCement®)

Photocatalyst: TiO₂ (Kronoclean 7000® of the company KRONOS®)

Fly ash: Coal fly ash (steament® H-4 of the company steag)°

Silica fume suspension: Microsilica suspension (Centrilit Fume SX® of the company MC Bauchemie®)

Aerogel granules: SiO2 aerogel (Aerogel Particles P100® of the company Cabot®)

Superplasticizer: High performance superplasticizer (MC-PowerFlow 3100® of the company MC Bauchemie®)

Stabilizer: organic stabilizer (Centrament Stabi 520® of the company MC Bauchemie®)

The photocatalyst used in mixture 1 is Photoment®, a mixture of TiO₂ (“Kronoclean 7000®”) and fly ash (“Steament H4®” of the company steag) at a ratio of ˜1:3. Ten percent by weight cement was replaced by Photoment®, resulting in the mixture components of TiO₂ and fly ash extrapolated back as stated in Table 1.

For preparing the mortar prisms, the dry components of the mixture, i.e., cement, photocatalyst and the aerogel granules, were premixed for 60 s in an intensive mixer. Thereafter, a mixture of ⅓ of the water to be added with the superplasticizer was prepared, and added to the dry premix. After adding the organic stabilizer and after a mixing time of another 60 s, a premix of ¼ of the water to be added and the silica fume suspension was added. After mixing again for 60 s, the dosing containers for the mixture of silica fume suspension and water and the superplasticizer were filled with 50% by volume each of the remaining water to be added, and discharged into the mixture. After a final mixing for 120 s, the intensive mixer was stopped, and the finished mixture was filled into the prepared formworks for the mortar prisms according to DIN EN 196. After storing in a water bath for 28 days, the compressive strength, the flexural strength and the photocatalytic activity were determined on the test specimens. The stated amount of aerogel granules corresponds to a proportion of 46 kg/m³.

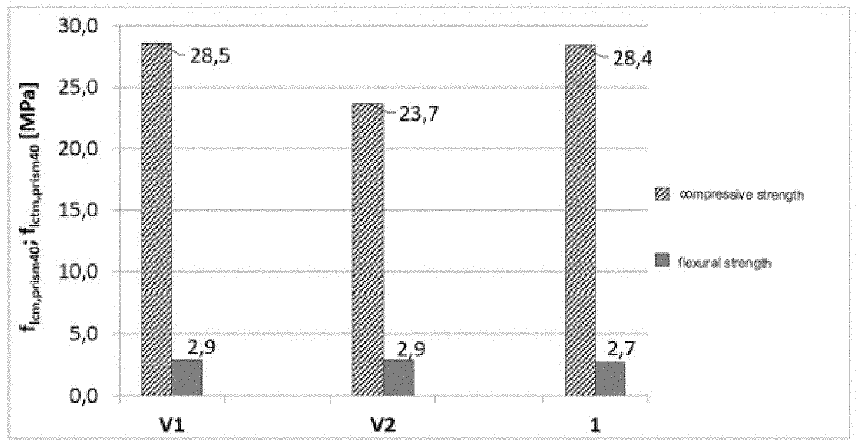

FIG. 1 shows the results of the compressive strength (DF) and flexural strength (BF) tests performed on the mortar prisms. The strengths established for reference mixture V1 (DF=28.5 MPa, BF=2.9 MPa) are slightly above the average values for HPAC mixtures with an aerogel proportion of 50% by volume. Thus, the replacement of 10% by weight cement by fly ash (mixture V2) resulted in a reduction of the compressive strength by 17% to 23.7 MPa, while the flexural strength remained unchanged. By substituting about 33% of the fly ash by titanium dioxide (mixture 1), the drop of compressive strength was compensated, while a reduction of flexural strength by 6% could be established (DF=28.4 MPa, BF=2.7 MPa).

From this, it can be concluded that, when the photocatalysts are used alone without fly ash (mixtures 2 and 3), higher compressive and flexural strengths as compared to the reference mixture are to be expected. However, it is known from the literature that TiO₂ without an admixture of fly ash tends to agglomeration, which may entail a deterioration of processability and homogeneity.

The samples of mixture 1 were treated with NOₓ gas under UV light in the laboratories of the Steag Power Minerals (SPM) in a photoreactor by analogy with ISO 22197-1. The degradation of NOₓ was measured after one, two, three and four hours, and a degradation rate of 1.77 mg/m²h was established. This corresponds to a relative degradation rate of 2.5%, and thus to a medium photocatalytic activity. From EP 2 597 073 A1, Table 3, it can be seen that, when only TiO₂ is used as a photocatalyst in normal concretes, comparable degradation rates with those of the mixtures with titanium dioxide and fly ash were established. Therefore, it is to be considered that even PA-HPAC without fly ash will exhibit at least medium degradation rates.

1. An aerogel concrete mix containing
from 10 to 85 kg/m³ of aerogel granules with a grain size within a range of from 0.01 to 4 mm,
100 to 900 kg/m³ of an inorganic binder,
10 to 360 kg/m³ of at least one silica fume suspension, based on the binder content,
1 to 45 kg/m³ of at least one superplasticizer, based on the binder content,
0.2 to 9 kg/m³ of at least one superplasticizer, based on the binder content,
0 to 1200 kg/m³ of at least one lightweight aggregate, wherein said aerogel concrete mix contains a photocatalyst.

2. The aerogel concrete mix according to claim 1, wherein said inorganic binder includes a hydraulic binder selected from cement.

3. The aerogel concrete mix according to claim 1, wherein the silica fume suspension contains from 1 to 60% by volume of active substance, solids content.

4. The aerogel concrete mix according to claim 1 containing from 0.05 to 300 kg/m³ of said photocatalyst.

5. The aerogel concrete mix according to claim 1, wherein said photocatalyst is selected from oxides of titanium, iron, zinc, tin, tungsten, niobium, tantalum, and mixtures thereof.

6. The aerogel concrete mix according to claim 5, wherein said photocatalyst is TiO₂.

7. The aerogel concrete mix according claim 1, further containing a material that inhibits the agglomeration of the photocatalyst.

8. A process for preparing an aerogel concrete comprising an aerogel concrete mix, the aerogel concrete mix containing:
from 10 to 85 kg/m³ of aerogel granules with a grain size within a range of from 0.01 to 4 mm,
100 to 900 kg/m³ of an inorganic binder,
10 to 360 kg/m³ of at least one silica fume suspension, based on the binder content,
1 to 45 kg/m³ of at least one superplasticizer, based on the binder content,
0.2 to 9 kg/m³ of at least one superplasticizer, based on the binder content,
0 to 1200 kg/m³ of at least one lightweight aggregate,
wherein said aerogel concrete mix contains a photocatalyst, the process comprising:
at first the binder, the photocatalyst, the aerogel and optionally lightweight aggregates are mixed, then a water-superplasticizer mixture and the stabilizer, in a mixing break a water-silica fume mixture is added, and after renewed mixing, the remaining water is added, and mixing is continued.

9. The process according to claim 8, wherein after a mixing time of 30 to 60 seconds each, the water-superplasticizer mixture and the stabilizer, then the mixture of water and silica fume in a mixing break, and after mixing again for 30 seconds to 2 minutes, the remaining water is added, and mixing is continued for another 1 to 10 minutes.

10. The process according to claim 8, wherein before the mixing, the water to be added is cooled to a temperature of less than 10° C.

11. Photocatalytically active high-performance aerogel concretes, in-situ concretes, precast concrete parts, facade elements, sprayed concrete linings, or outer layers of graded wall elements, obtainable by a process according to claim 8.

12. A method of using an aerogel concrete mix according to claim 1 for photocatalytic surfaces, especially for degrading nitric oxides.

13. A method of using a photocatalytic high-performance aerogel concrete, in-situ concrete, precast concrete part, facade element, sprayed concrete lining, or outer layer of graded wall elements for photocatalytic surfaces, for degrading nitric oxides.

14. The aerogel concrete mix according to claim 2, wherein the cement is Portland cement.

15. The aerogel concrete mix according to claim 3, wherein the silica fume suspension contains 50% by volume of the active substance.

16. The aerogel concrete mix according to claim 4 containing from 2.5 to 60 kg/m³ of the photocatalyst.

17. The aerogel concrete mix according to claim 7, wherein the material is fly ash.

18. The process according to claim 10, wherein the water is cooled to less than 5° C.

19. The aerogel concrete mix according to claim 6, further containing fly ash.
